(19) United States
(12) Patent Application Publication
(10) Pub. No.: US 2026/0126152 A1
(43) Pub. Date: May 7, 2026

(54) CONTROLLED DOSING OF LIQUID CRYOGEN

(71) Applicant: Vacuum Barrier Corporation, Woburn, MA (US)

(72) Inventors: Erik Robert Showers, Boxford, MA (US); John Walker Ross, Ipswich, MA (US); David Tucker, Groveland, MA (US)

(21) Appl. No.: 19/426,895

(22) Filed: Dec. 19, 2025

Related U.S. Application Data
(63) Continuation-in-part of application No. 18/678,412, filed on May 30, 2024.
Application No. 18/678,412 is a continuation of application No. 18/425,621, filed on Jan. 29, 2024, now Pat. No. 12,031,680.
(60) Provisional application No. 63/623,393, filed on Jan. 22, 2024.

(51) Int. Cl. F17C 13/04; B67C 3/00; B67C 3/26

(52) U.S. Cl. CPC F17C 13/04; B67C 3/005; B67C 3/26; F17C 2205/0326; F17C 2221/014; F17C 2223/0161; F17C 2260/038; F17C 2270/059

(57) ABSTRACT

A liquid cryogen dosing head has a liquid cryogen reservoir in communication with a dosing outlet, a dosing valve stem having a lower, distal end configured to selectively open and close the dosing outlet, and an electromagnetic actuator attached to an upper end of the dosing valve stem above the liquid cryogen reservoir and operable to move the dosing valve stem to open and close the dosing outlet. The electromagnetic actuator is disposed above the liquid cryogen reservoir and the dosing valve stem extends through the liquid cryogen reservoir, preferably concentrically, to open and close the dosing outlet by blocking an orifice of the dosing outlet.

### CLAIM OF PRIORITY

This application claims priority under 35 USC § 120 as a continuation-in-part of pending U.S. patent application Ser. No. 18/678,412, filed May 30, 2024, which claimed priority under 35 USC § 120 to U.S. patent application Ser. No. 18/425,621, filed Jan. 29, 2024 and now U.S. Pat. No. 12,031,680, which claimed priority under 35 USC § 119(e) to U.S. Provisional Patent Application Ser. No. 63/623,393, filed on Jan. 22, 2024, the entire contents of each of which are hereby incorporated by reference.

### TECHNICAL FIELD

This invention relates to systems and methods for delivering controlled doses of a liquid cryogen, such as liquid nitrogen.

### BACKGROUND

In some processes, it is important to deliver a known amount of a cryogenic liquid. For example, doses of liquid nitrogen are delivered to containers that are then capped immediately in a beverage packaging line so that nitrogen vaporizing after capping pressurizes the container. In that process, the amount of liquid delivered must be carefully controlled. If too little liquid cryogen is administered, the container may collapse when it experiences significant forces. If too much liquid cryogen is delivered, excessive pressure builds up in the container causing it to deform or rupture. Even when liquid cryogen (usually nitrogen) is provided as a source of inert gas in the container and not to pressurize it, cryogen delivery must be reliable and consistent without gaps or surges of liquid.

Controlling the amount or dose of liquid nitrogen delivered can be difficult, particularly if the doses must be rapidly administered as is the case for a high speed canning or bottling assembly line. The large change in density resulting from vaporization of liquid means that devices dispensing a predetermined volume of fluid, such as valves, will not provide consistent amounts of cryogen unless the vapor/liquid state of the fluid is controlled.

Some liquid cryogen dosing needs to be done under aseptic conditions, and some other dosing may be done under non-aseptic conditions.

### SUMMARY

According to one aspect of the invention, a liquid cryogen dosing head includes a liquid cryogen reservoir in communication with a dosing outlet, a dosing valve stem having a lower, distal end configured to selectively open and close the dosing outlet, and an electromagnetic actuator attached to an upper end of the dosing valve stem and operable to move the dosing valve stem to open and close the dosing outlet. The electromagnetic actuator is disposed above the liquid cryogen reservoir and the dosing valve stem extends through the liquid cryogen reservoir to open and close the dosing outlet by blocking an orifice of the dosing outlet.

In some embodiments, the liquid cryogen reservoir through which the dosing valve stem extends is sized to contain a depth of at least 10 centimeters of liquid cryogen. The dosing valve stem is preferably exposed to an interior of the liquid cryogen reservoir over a distance that is at least 10 times an average lateral extent of the dosing valve stem within the liquid cryogen reservoir. In embodiments in which the dosing valve stem forms a cylindrical rod above its lower, distal end, the dosing valve stem is preferably exposed to an interior of the liquid cryogen reservoir over a distance that is at least 10 times a diameter of the cylindrical rod.

In some embodiments, the liquid cryogen reservoir is cylindrical and the dosing valve stem extends parallel to a vertical axis of the reservoir. In some cases it extends along the vertical axis.

In some applications, the dosing outlet has a valve seat positioned to be engaged by the distal end of the dosing valve stem to close the dosing outlet, and the liquid cryogen reservoir extends to a level lower than the valve seat.

Some embodiments also include a seal extending about the dosing valve stem and separating the liquid cryogen reservoir from a cavity between the seal and the electromagnetic actuator, the seal providing an air-tight seal during operation. In some applications, a controller is operable to perform a sterilization cycle of the head, including introducing a pressurized sterilization fluid into the reservoir while introducing a gas at a countering pressure into the cavity, thereby keeping the dosing outlet in a closed condition during sterilization. In some examples, the seal features a diaphragm secured to the dosing valve stem.

In some embodiments, the liquid cryogen reservoir is contained within a housing connecting the dosing outlet with the electromagnetic actuator, and the housing and the dosing valve stem are fashioned primarily of materials with coefficients of thermal expansion that differ by less than one percent. Both the housing and the dosing valve stem may be fashioned of stainless steel, for example.

In some applications, the electromagnetic actuator comprises a servomotor. The electromagnetic actuator may be controllable to alter a dosing valve stem displacement distance and duration, and/or controllable to alter a rest position of the dosing valve stem with respect to the dosing outlet.

In some cases, the dosing head also includes a dosing outlet gas flow valve controllable to introduce a flow of sterile gas from a pressurized source to the dosing outlet to inhibit frost accumulation. The dosing outlet gas flow valve may be controllable to open when the electromagnetic actuator is not operating to dispense a dose of liquid cryogen. In some examples, the dosing outlet gas flow valve includes a fixed bypass orifice that allows a continuous flow of the sterile gas to the dosing outlet when the electromagnetic actuator is operating to dispense a dose of liquid cryogen. The dosing outlet gas flow valve may be arranged to introduce the flow of the sterile gas to a portion of the dosing outlet open to atmospheric pressure.

In some examples, the lower, distal end of the dosing valve stem has a thermoplastic cap that engages a seat of the dosing outlet.

According to another aspect of the invention, a liquid cryogen dosing head has a liquid cryogen reservoir in communication with a dosing outlet having a seat, a dosing valve stem having a lower, distal end configured to selectively open and close the dosing outlet by engaging the seat, and an actuator attached to an upper end of the dosing valve stem and operable to move the dosing valve stem to open and close the dosing outlet. The liquid cryogen reservoir extends to below the dosing outlet seat, such that liquid cryogen contained within the reservoir surrounds the dosing outlet.

In some embodiments, the liquid cryogen reservoir has a horizontal floor surface below the dosing outlet. In some cases, the horizontal floor surface spans an overall width of the reservoir.

In some examples, the dosing outlet has a nozzle contained within a nozzle jacket that is exposed to liquid cryogen in the reservoir during use, the nozzle having a surface forming the seat. In some cases, the nozzle is removable. The nozzle jacket preferably has a lateral extent of no more than 0.3 times an overall lateral extent of the reservoir at an elevation of the outlet seat.

In some embodiments, the liquid cryogen reservoir includes an annular extension disposed below the valve seat. Preferably, the annular extension has a volume equivalent to at least 500 discrete doses, or at least 25 ml, of liquid cryogen. In some cases, the dosing outlet comprises a nozzle contained within a nozzle jacket having an outer diameter of at least 100 times a diameter of the nozzle orifice. Preferably, the reservoir extension has an outer diameter at least 200 times the nozzle orifice diameter. The outer diameter of the reservoir extension is preferably less than half of an overall inside diameter of the reservoir.

In some embodiments, the actuator is an electromagnetic actuator.

At least many embodiments of the invention can provide a particularly high dosing speed in a relatively compact and efficient head, with good quality, consistent, discrete doses.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a schematic diagram of a first embodiment of a liquid cryogen delivery system for controlled dosing of liquid cryogen.

FIGS. 2A and 2B are schematic cross-sections through alternate configurations of the lower portion of the reservoir of the dosing head.

FIG. 3 is a schematic diagram of a second embodiment of a liquid cryogen delivery system for controlled dosing of liquid cryogen.

Like reference symbols in the various drawings indicate like elements.

### DETAILED DESCRIPTION

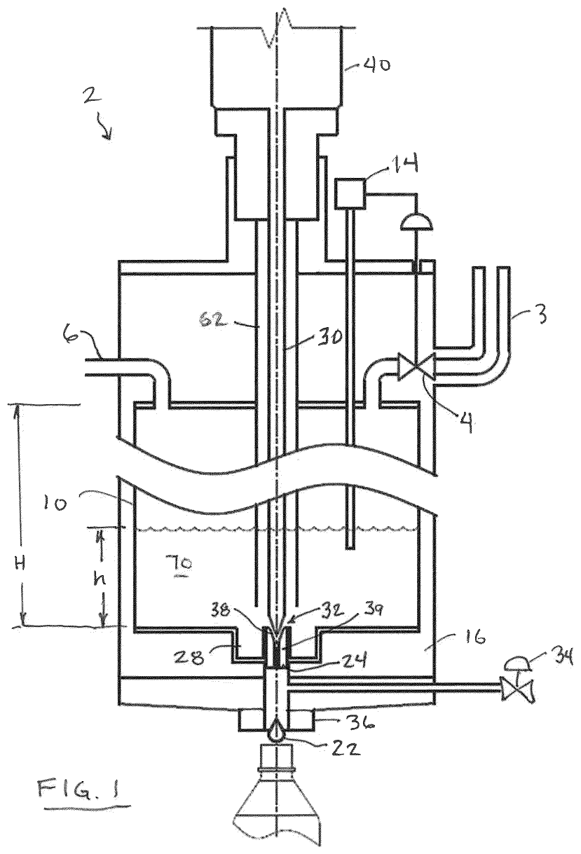

Referring first to FIG. 1, in non-aseptic liquid cryogen dosing head 2, cryogen is supplied from a pressurized source and travels through vacuum jacketed piping 3 through a controllable inlet valve 4 into a phase separating reservoir 10. By reservoir we refer to the interior cavity of the reservoir vessel. Fill valve 4 can be controlled to maintain the liquid cryogen level at a desired height in the phase separating reservoir 10. A filter (not shown) is located in the piping 3 before inlet valve 4, which prevents unwanted particles from entering the reservoir. As the two-phase cryogen mixture flows into the reservoir 10, the gas phase is vented to atmosphere through vent conduit 6. The liquid phase collects in reservoir 10 and is maintained at a constant level by controlling valve 4 in response to a level sensor 14. The pressure head at the dosing valve is controlled by controlling the level of liquid cryogen in the reservoir. The entire reservoir vessel is encased within a vacuum insulation chamber 16 to minimize heating.

The dosing valve is controlled to dispense discrete doses 22 of liquid cryogen, such as liquid nitrogen, from the dosing outlet 24 arranged such that each dispensed dose 22 falls into a container 26 passing under the outlet. The dosing valve may be controllably cycled at a high rate, to dispense discrete doses 22 at a rate of up to, for example, 2,000 doses per minute, each dose falling into a respective container. Each dose may be, for example, between 0.01 and 1.0 ml of liquid cryogen. The container moves to a sealing station (e.g., a capping station for bottles) after dosing. For pressurized containers, sealing occurs before the dosed cryogen has fully evaporated.

The dosing valve has a valve stem 30 that cycles vertically to seat and unseat against a valve seat 32 at the dosing outlet, thereby closing and opening the outlet. The stem is stainless steel with a tip of thermoplastic to provide a sealing surface. When the outlet is open, liquid cryogen is forced through the outlet by static pressure within the reservoir, as determined by the level of liquid. The valve seat is a surface of the outlet nozzle, which may define a fixed output orifice of, for example, 0.065 inch diameter (in some cases between 0.015 and 0.12 inch diameter). Valve stem 30 is cycled by an electromagnetic linear actuator 40 that pushes and pulls on the valve stem in response to controlled electromagnetic force. In operation, actuator 40 can be controlled to modulate the amount of lift of the valve stem, and to alter the open and close rate of the dosing outlet, thereby changing the dosage volume and dispensing parameters to as needed for optimum dosing. Control of the dosing volume can be, for example, a function of a sensed container pressure downstream of the sealing station. Changing the dosing parameters by control of the linear actuator avoids the need to shut down the line to change orifice sizes within the nozzle.

Linear actuator 40, in this example, is a linear servomotor (electric cylinder) with a built-in encoder having a resolution of 5 μm, an operating voltage of 48 VDC, a maximum stroke of 10 mm, and a peak output force of 100 N. Suitable actuators are available commercially. Such an actuator may be precisely controlled by pulse-width modulation, for example. An electrical solenoid, or a stepper motor with a drivetrain, may alternatively be employed as the linear actuator, so long as they meet the speed and precision requirements of the dosing application.

A dosing outlet gas flow valve 34 is controllable to introduce a flow of dry inert gas from a pressurized source (not shown) to the dosing outlet to help inhibit frost accumulation at the dosing outlet. The dosing outlet gas flow valve is preferably controlled to open when the electromagnetic actuator is not operating to dispense a dose of liquid cryogen, and to close during dosing. Dosing outlet gas flow valve 34 includes a fixed bypass orifice that allows a continuous flow of the inert gas to the dosing outlet when the electromagnetic actuator is operating to dispense a dose of liquid cryogen. In this manner, a small flow of inert gas is always flowing out of the outlet to keep the outlet clean and frost-free, and a high flow of inert gas flows during periods of non-dosing. As illustrated, the dosing outlet gas flow valve is arranged to introduce the flow of the gas to a portion of the dosing outlet open to atmospheric pressure. A heated containment plate 36 at the outlet works in combination with the purge gas from valve 34 to maintain warm, ice free surfaces during liquid cryogen dosing. Alternatively, a constant small flow of nitrogen can be provided directly from the reservoir through suitable tubing as a purge gas, eliminating the need for a separate purge gas supply.

Dosing valve stem 30 extends vertically from the linear actuator 40, which sits above the reservoir, to the dosing outlet 24 at the bottom of the reservoir. The reservoir itself is sized to contain a substantial amount of liquid cryogen, preferably enough for at least 1,000 discrete doses. In this illustration, the liquid cryogen 70 is shown having an instantaneous depth ‘h’ of about 22 centimeters, over all of which the dosing valve stem 30 is in contact with the liquid cryogen. The reservoir has a total height ‘H’ of about 55 centimeters. The level of available liquid cryogen is maintained by sensor 14 and fill valve 4, to keep a substantial amount of cryogen in the reservoir at all times during operation. The reservoir is sized to contain a depth of at least 10 cm of liquid cryogen. Preferably, the dosing valve stem is exposed to an interior of the liquid cryogen reservoir over a distance that is at least 10 times an average lateral extent of the dosing valve stem (in the case of a cylindrical valve stem rod, a distance of at least 10 times the rod diameter) within the liquid cryogen reservoir. A tube 62 extends from the actuator down into the reservoir 10 from above to below the free surface of the liquid cryogen 70 in the reservoir, encircling the dosing valve stem 30 but not restricting the liquid cryogen from contacting the dosing valve stem. Sealing of the actuator from cryogen vapor is provided by seals within the actuator.

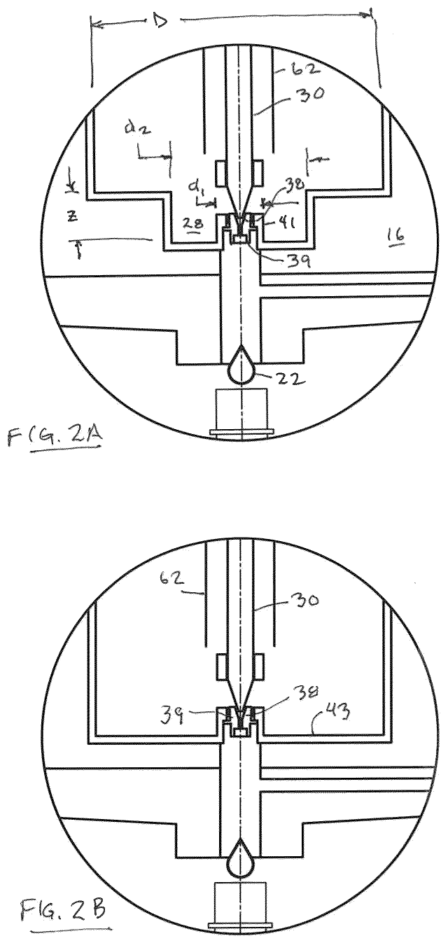

Referring also to FIG. 2A, at the bottom of the reservoir an annular extension 28 of the reservoir surrounds the dosing outlet and helps to maintain the dosing outlet surfaces of the nozzle 39 at a consistent low temperature, helping with dosing quality. The extension extends to below the valve seat 38, by which we mean that the volume of cryogen within the extension in use extends to below the lowest contact point between the surface of the nozzle and the valve stem 30 when the nozzle outlet is closed by the valve stem. The removable nozzle 39 is threaded into a nozzle jacket 41 that has an outer diameter d1 at which the jacket is fully exposed to the liquid cryogen to a depth at least to below the valve seat 38. In this example, the nozzle jacket diameter d1 is about 25 mm and the outer diameter d2 of the reservoir extension 28 is about 70 mm. The reservoir extension preferably has a volume of at least 25 ml, or equivalent to at least 500 doses of cryogen above a flat, horizontal bottom surface. This volume is not necessarily self-draining and may empty only by evaporation.

The nozzle jacket diameter d1 is about 100 times the nozzle orifice diameter, and the outer diameter d2 of the reservoir extension is preferably at least 200 times the nozzle orifice diameter and less than half of the overall inside diameter ‘D’ of the reservoir.

In the example shown in FIG. 2B the bottom surface 43 of the reservoir is flat, disposed horizontally in use at an elevation below the valve seat 38 and spanning the overall width of the inside of the reservoir. As compared to the arrangement shown in FIG. 2A, for a given reservoir width this reservoir configuration leaves a greater volume of cryogen within the reservoir when the reservoir is drained through the dosing outlet. The reservoir lower end configurations shown in FIGS. 2A and 2B may also be employed in dosing heads with non-electromagnetic actuators, such as pneumatic actuators.

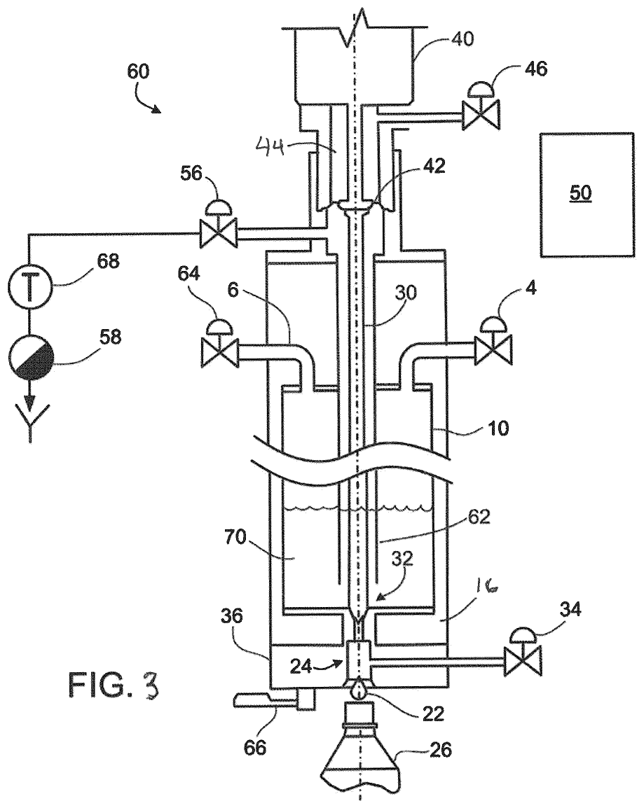

Referring next to FIG. 3, an aseptic cryogenic dosing head 60 is similar in function to the system shown in FIG. 1, with the cryogen reservoir surrounding the valve stem 30, but with a diaphragm 42 that forms a seal that extends about the dosing valve stem and separates the liquid cryogen reservoir from a cavity 44 between the diaphragm and the electromagnetic actuator 40. The diaphragm provides an air-tight, annular, sterile seal, with an inner portion of the diaphragm secured to the valve stem and an outer portion of the seal secured to the surrounding structure, such as by being captured at the inner end of a fitting that mounts the actuator. In this example the valve stem has an upper section secured to the actuator, and a lower section extending to the valve seat. The two sections are threaded together at the diaphragm. The diaphragm flexes during each actuation cycle of the valve stem, allowing the stem to move a vertical distance of up to about 0.1 inch (2.5 mm) for a full stroke. Diaphragm 42 can be of EPDM molded over a fabric core, for example. Alternatively, diaphragm 42 can be a metal bellows.

In this example, the reservoir vent valve 64 is shown. As in the example of FIG. 1, all valves are controlled by a controller 50 to perform diaphragm and leakage tests as described in U.S. Pat. No. 12,031,680, as well as a sterilization of the aseptic space and surfaces. This example also shows a shutter 66 controlled to pivot to cover the dosing outlet during sterilization and when the system is not in use. The shutter defines a small hole through which condensate can exit the dosing outlet cavity during sterilization. Some system components, such as a level switch or sensor coupled to fill valve 4, and various pressure and temperature sensors (other than a temperature sensor 68 in the steam vent line) are not shown, for clarity.

The lower end of the reservoir 10 of the aseptic dosing system of FIG. 3 can be configured either as in FIG. 2A or FIG. 2B, for improved dosing quality.

Aseptic dosing also requires that the mechanical components of the system withstand extreme temperature changes, such as from −320 F liquid nitrogen temperatures during operation, to +250 F steam temperatures during sterilization. Such high temperature changes can cause significant issues due to thermal expansion. Given that the dosing valve stem can be up to 30 inches long in an aseptic system, care must be taken to avoid problems due to changes in overall length of the valve stem due to thermal expansion. For example, the structure connecting the dosing outlet to the linear actuator should be of materials with an overall net coefficient of expansion identical to, or substantially identical to, that of the valve stem. Preferably, the housing and the dosing valve stem are fashioned primarily of materials with coefficients of thermal expansion that differ by less than one percent. In this example such structure is also made of stainless steel. Additionally, a homing signal can be sent to the linear actuator after the valve stem has been submerged in liquid cryogen for a period of time.

While a number of examples have been described for illustration purposes, the foregoing description is not intended to limit the scope of the invention, which is defined by the scope of the appended claims. There are and will be other examples and modifications within the scope of the following claims.

What is claimed is:

1. A liquid cryogen dosing head, comprising
a liquid cryogen reservoir in communication with a dosing outlet;
a dosing valve stem having a lower, distal end configured to selectively open and close the dosing outlet; and
an electromagnetic actuator attached to an upper end of the dosing valve stem and operable to move the dosing valve stem to open and close the dosing outlet;
wherein the electromagnetic actuator is disposed above the liquid cryogen reservoir and the dosing valve stem extends through the liquid cryogen reservoir to open and close the dosing outlet by blocking an orifice of the dosing outlet.

2. The liquid cryogen dosing head of claim 1, wherein the liquid cryogen reservoir through which the dosing valve stem extends is sized to contain a depth of at least 10 centimeters of liquid cryogen.

3. The liquid cryogen dosing head of claim 1, wherein the dosing valve stem is exposed to an interior of the liquid cryogen reservoir over a distance that is at least 10 times an average lateral extent of the dosing valve stem within the liquid cryogen reservoir.

4. The liquid cryogen dosing head of claim 1, wherein the liquid cryogen reservoir is cylindrical and wherein the dosing valve stem extends parallel to a vertical axis of the reservoir.

5. The liquid cryogen dosing head of claim 1, wherein the dosing outlet comprises a valve seat positioned to be engaged by the distal end of the dosing valve stem to close the dosing outlet, and wherein the liquid cryogen reservoir extends to a level lower than the valve seat.

6. The liquid cryogen dosing head of claim 1, further comprising a seal extending about the dosing valve stem and separating the liquid cryogen reservoir from a cavity between the seal and the electromagnetic actuator, the seal providing an air-tight seal during operation.

7. The liquid cryogen dosing head of claim 6, further comprising a controller operable to perform a sterilization cycle of the head, comprising introducing a pressurized sterilization fluid into the reservoir, while introducing a gas at a countering pressure into the cavity, thereby keeping the dosing outlet in a closed condition during sterilization.

8. The liquid cryogen dosing head of claim 6, wherein the seal comprises a diaphragm secured to the dosing valve stem.

9. The liquid cryogen dosing head of claim 1, wherein the liquid cryogen reservoir is contained within a housing connecting the dosing outlet with the electromagnetic actuator, and wherein the housing and the dosing valve stem are fashioned primarily of materials with coefficients of thermal expansion that differ by less than one percent.

10. The liquid cryogen dosing head of claim 9, wherein both the housing and the dosing valve stem are fashioned of stainless steel.

11. The liquid cryogen dosing head of claim 1, wherein the electromagnetic actuator comprises a servomotor.

12. The liquid cryogen dosing head of claim 1, wherein the electromagnetic actuator is controllable to alter a dosing valve stem displacement distance and duration.

13. The liquid cryogen dosing head of claim 1, wherein the electromagnetic actuator is controllable to alter a rest position of the dosing valve stem with respect to the dosing outlet.

14. The liquid cryogen dosing head of claim 1, further comprising a dosing outlet gas flow valve controllable to introduce a flow of sterile gas from a pressurized source to the dosing outlet to inhibit frost accumulation.

15. The liquid cryogen dosing head of claim 14, wherein the dosing outlet gas flow valve is controllable to open when the electromagnetic actuator is not operating to dispense a dose of liquid cryogen.

16. The liquid cryogen dosing head of claim 14, wherein the dosing outlet gas flow valve includes a fixed bypass orifice that allows a continuous flow of the sterile gas to the dosing outlet when the electromagnetic actuator is operating to dispense a dose of liquid cryogen.

17. The liquid cryogen dosing head of claim 14, wherein the dosing outlet gas flow valve is arranged to introduce the flow of the sterile gas to a portion of the dosing outlet open to atmospheric pressure.

18. The liquid cryogen dosing head of claim 1, wherein the lower, distal end of the dosing valve stem comprises a thermoplastic cap that engages a seat of the dosing outlet.

19. A liquid cryogen dosing head, comprising
a liquid cryogen reservoir in communication with a dosing outlet having a seat;
a dosing valve stem having a lower, distal end configured to selectively open and close the dosing outlet by engaging the seat; and
an actuator attached to an upper end of the dosing valve stem and operable to move the dosing valve stem to open and close the dosing outlet;
wherein the liquid cryogen reservoir extends to below the dosing outlet seat, such that liquid cryogen contained within the reservoir surrounds the dosing outlet.

20. The liquid cryogen dosing head of claim 19, wherein the liquid cryogen reservoir has a horizontal floor surface below the dosing outlet.

21. The liquid cryogen dosing head of claim 20, wherein the horizontal floor surface spans an overall width of the reservoir.

22. The liquid cryogen dosing head of claim 19, wherein the dosing outlet comprises a nozzle contained within a nozzle jacket that is exposed to liquid cryogen in the reservoir during use, the nozzle having a surface forming the seat.

23. The liquid cryogen dosing head of claim 19, wherein the nozzle is removable.

24. The liquid cryogen dosing head of claim 23 wherein the nozzle jacket has a lateral extent of no more than 0.3 times an overall lateral extent of the reservoir at an elevation of the outlet seat.

25. The liquid cryogen dosing head of claim 19, wherein the liquid cryogen reservoir includes an annular extension disposed below the valve seat.

26. The liquid cryogen dosing head of claim 25, wherein the annular extension has a volume equivalent to at least 500 discrete doses, or at least 25 ml, of liquid cryogen.

27. The liquid cryogen dosing head of claim 25, wherein the dosing outlet comprises a nozzle contained within a nozzle jacket having an outer diameter of at least 100 times a diameter of the nozzle orifice.

28. The liquid cryogen dosing head of claim 27, wherein the reservoir extension has an outer diameter at least 200 times the nozzle orifice diameter.

29. The liquid cryogen dosing head of claim 27, wherein the outer diameter of the reservoir extension is less than half of an overall inside diameter of the reservoir.

30. The liquid cryogen dosing head of claim 19, wherein the actuator comprises an electromagnetic actuator.
